(19) United States
(12) Patent Application Publication
(10) Pub. No.: US 2011/0156375 A1
(43) Pub. Date: Jun. 30, 2011

(54) CART AND METHOD THEREFOR

(76) Inventor: Alexander Gal, Yavne (IL)

(21) Appl. No.: 12/978,668

(22) Filed: Dec. 27, 2010

(30) Foreign Application Priority Data
Dec. 31, 2009 (IL) IL 203111

(51) Int. Cl. B62B 3/02

(52) U.S. Cl. 280/651

(57) ABSTRACT

In one aspect, the present invention is directed to a foldable and deployable cart (2), the cart comprising: at least one pedestal (10) substantially perpendicular to the floor at the deployed state; at least one top horizontal bar (36), substantially perpendicular to the at least one pedestal (10) at the deployed state; pivotal connection (52) between the at least one pedestal (10) and the at least one top horizontal bar (36), for rotating the at least one pedestal (10) thereabout to be substantially parallel to the at least one top horizontal bar (10), thereby allowing resting a luggage box (12), supported by the at least one top horizontal bar (36), on a trunk (30) and folding the at least one pedestal (10) into the trunk (30).

### FIELD OF THE INVENTION

The present invention relates to the field of carts, such as shopping carts. More particularly, the invention relates to a cart comprising a mechanism for placing the basket thereof in a car, thereby saving the owner the need to unload groceries into the car trunk.

### BACKGROUND OF THE INVENTION

A shopping cart is a cart for transporting groceries and the like by a customer (a) during shopping, (b) to the checkout counter, and usually (c) to the customer's car.

A typical shopping cart comprises the following parts:
a basket, for carrying groceries;
a pedestal assembly, a facility that supports the basket; and
wheels, attached to the lower side of the pedestal assembly, on which the cart moves.

One of the drawbacks of shopping carts is the need to unload the groceries from the cart into the car, an operation that is time-consuming and may be unpleasant under extreme weather conditions, such as a rainy day, during a heat wave, and so on. Furthermore, after reaching home, a user must unload the groceries, and move them, usually in bags, into his residence.

U.S. Pat. No. 6,024,527 discloses a shopping cart modified for vehicle transport that provides shoppers with a personal shopping cart they retain and use to transport groceries from the store to their home without unloading the groceries out of the cart multiple times. However, the cart is disassembled from the basket.

US Publication No. US20070126192 discloses a shopping cart including a modification for lifting and holding the entire shopping cart while the car is moving. The drawback of this solution is that the entire shopping cart is outside the car while in transport, thereby exposing it to the possibility of disconnecting from the vehicle, or rendering groceries vulnerable to spillage, security problems, and so on.

It is an object of the present invention to provide a cart which overcomes the above-mentioned drawbacks of the prior art, and others.

Other objects and advantages of the invention will become apparent as the description proceeds.

### SUMMARY OF THE INVENTION

In one aspect, the present invention is directed to a foldable and deployable cart (2), the cart comprising:
at least one pedestal (10) substantially perpendicular to the floor at the deployed state;
at least one top horizontal bar (36), substantially perpendicular to the at least one pedestal (10) at the deployed state;
pivotal connection (52) between the at least one pedestal (10) and the at least one top horizontal bar (36), for rotating the at least one pedestal (10) thereabout to be substantially parallel to the at least one top horizontal bar (10),
   thereby allowing resting a luggage box (12), supported by the at least one top horizontal bar (36), on a trunk (30) and folding the at least one pedestal (10) into the trunk (30).

The pedestals (10) may comprise two pedestals (10), one at the left and one at the right of the luggage box (12); and
the top horizontal bars (36) may comprise two top horizontal bars (36), one at the left and one at the right of the luggage box (12);
   thereby the folding of the pedestals (10) may comprise folding thereof to the sides of the luggage box (12), saving space above the luggage box (12).

The cart (2) may further comprise:
at least one joining bar (46) between the two pedestals (10); and
at least one joining bar (handle 14) between the two top horizontal bars (36),
   thereby forming a frame.

The at least one joining bar (46) may be disposed in front of (FIG. 8, 15) or behind (FIG. 13) the luggage box (12) at the folded state of the cart (2), thereby saving space above the luggage box (12).

The rotation of the pedestals (10) to be substantially parallel to the top horizontal bars (36) may comprise: rotation of substantially 270 degrees (FIGS. 8, 10) from the state of perpendicularity to the floor.

The rotation of the pedestal (36) to be substantially parallel to the top horizontal bar (10) may comprise: rotation of substantially 90 degrees (FIG. 13) from the state of perpendicularity to the floor.

The cart (2) may further comprise:
a reducing mechanism (68), for reducing the length of the pedestals (10).

The reducing mechanism (68) may comprise a folding mechanism (44) for folding arms (42, 38) of the pedestals one towards the other.

The reducing mechanism (68) may comprise a telescopic mechanism (54) for providing telescopic reduction of the pedestals (10).

The reducing mechanism may comprise a crossbreed folding mechanism (66) providing crossbreed folding reduction of the pedestals (10).

The cart (2) may further comprise at least one bottom horizontal bar (34) extending the pedestals (10) substantially perpendicular thereto at the deployed state, the bottom horizontal bar (34) for supporting the pedestal (10).

The cart (2) may further comprise:
a luggage box (12) resting on the at least one horizontal bar (36); and
slideable connection (62) between the luggage box (12) or support (60) of the luggage box (12) and the at least one horizontal bar (36).

The at least one bottom horizontal bar (34) may be pivotally (48) connected to the pedestals (10), for folding the at least one bottom horizontal bar (34) to be attached to the pedestals (10) at the folded state.

In another aspect, the present invention is directed to a method for using a cart (2), the method comprising the steps of:
disposing a luggage box (12) of the cart (2) above a trunk (30);
resting the luggage box (12) on the trunk (30); and
rotating pedestals (10) of the cart (2), for folding the pedestals (10) into the trunk (30).

The step of disposing the luggage box (12) above the trunk (30) may comprise disposing bottom horizontal bars (34) of the cart (2) beneath the trunk (30).

The method may further comprise the step of:
sliding the luggage box (12) horizontally in relation to the pedestals (10).

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 is a perspective view of a cart according to one embodiment of the present invention.

FIG. 2 is a top view of the cart of FIG. 1 according to another embodiment.

FIG. 3 is a side view of the cart of FIG. 1 brought towards a car's trunk.

FIG. 4 is a side view of the first step of folding the cart of FIG. 1 into the car's trunk.

FIG. 5 is a side view of the second and third steps of folding the cart of FIG. 1 into the car's trunk.

FIG. 6 is a side view of the result of the third step of FIG. 5.

FIG. 7 is a side view of the fourth step of folding the cart of FIG. 1 into the car's trunk.

FIG. 8 is a side view of the fifth step of folding the cart of FIG. 1 into the car's trunk.

FIG. 9 is a perspective view of a cart according to another embodiment of the present invention.

FIG. 10 depicts the first and second steps of inserting the cart of FIG. 9 into the car's trunk.

FIG. 11 depicts the second and third step of inserting the cart of FIG. 9 into the car's trunk.

FIG. 12 depicts the fourth step of inserting the cart of FIG. 9 into the car's trunk.

FIG. 13 depicts the fifth step of inserting the cart of FIG. 9 into the car's trunk.

FIG. 14 depicts the resulting state of the fifth step of FIG. 13.

FIG. 15 depicts the sixth step of inserting the cart of FIG. 9 into the car's trunk.

FIG. 16 depicts another reducing mechanism, for reducing the pedestal.

It should be understood that the drawings are not necessarily drawn to scale.

### DETAILED DESCRIPTION OF THE INVENTION

The present invention will be understood from the following detailed description of preferred embodiments, which are meant to be descriptive and not limiting. For the sake of brevity, some well-known features, methods, systems, procedures, components, circuits, and so on, are not described in detail.

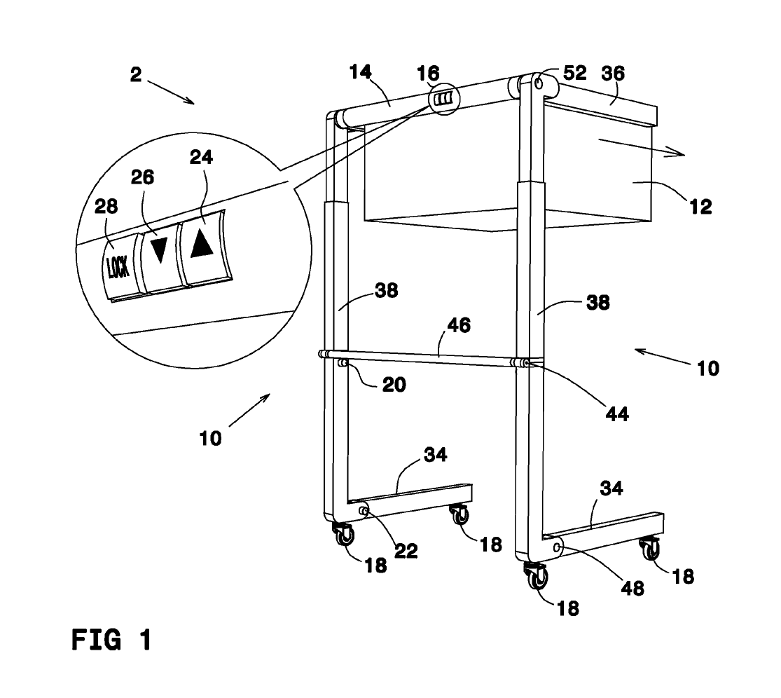

FIG. 1 is a perspective view of a cart according to one embodiment of the present invention.

A cart 2 according to the present invention includes two top horizontal bars 36, one at the left and one at the right. Each top horizontal bar 36 leans on a vertical pedestal 10, each pedestal 10 leans on a bottom horizontal bar 34.

A basket or a luggage-box 12 may rest on top horizontal bars 36.

Top horizontal bars 36 and bottom horizontal bars 34 both extend to the same side of pedestals 10, i.e., top horizontal bars 36 are disposed above bottom horizontal bars 34. Thus, bottom horizontal bars 34 support the weight of luggage box 12 from turning cart 2 upside down.

Pedestals 10 and bottom horizontal bar 34 thereof include together four wheels 18.

A horizontal handle 14 or luggage box 12 at the top, and a horizontal rod 46 below connect the side bars, completing the frame of the cart.

Pushing the handle 14 moves the cart based on wheels 18. Cart 2 may be folded after opening safety-latches 20 and 22. Handle 14 may include a user interface 16 for folding or deploying cart 2.

For example, button 24 of user interface 16 may raise top horizontal bars 36, button 26 may lower top horizontal bars 36, and button 28 may lock or unlock the raising and the lowering.

As expressed by user interface 16, only the raising and lowering requires an electric motor.

According to one embodiment, luggage box 12 is slideably connected to top horizontal bars 36, such as by trolley hangers and tracks, allowing forward and backwards movement between luggage box 12 and top horizontal bars 36.

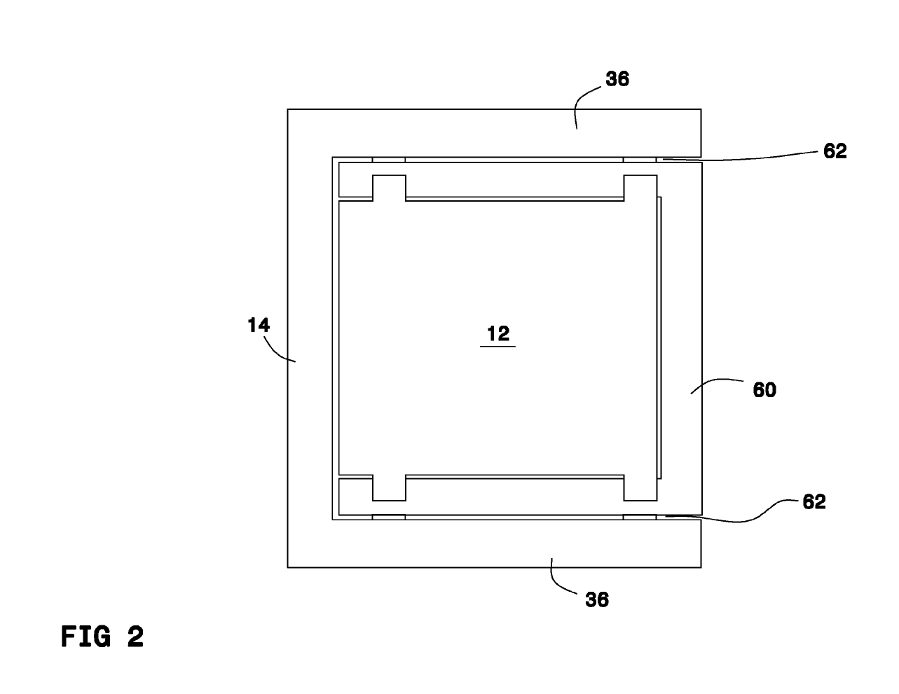

FIG. 2 is a top view of the cart of FIG. 1, according to another embodiment.

According to another embodiment, luggage box 12 rests on a basket support 60 and may be separated therefrom; basket support 60 is slideably connected to top horizontal bars 36, such as by trolley hangers and tracks, allowing forward and backwards movement therebetween.

The term “slideable connection” denoted by numeral 62 refers herein to the connection between luggage box 12 and top bars 36, allowing sliding between them, either allowing removal of luggage box 12 from top bars 36 like FIG. 2, or not allowing the removal, as depicted by FIG. 1.

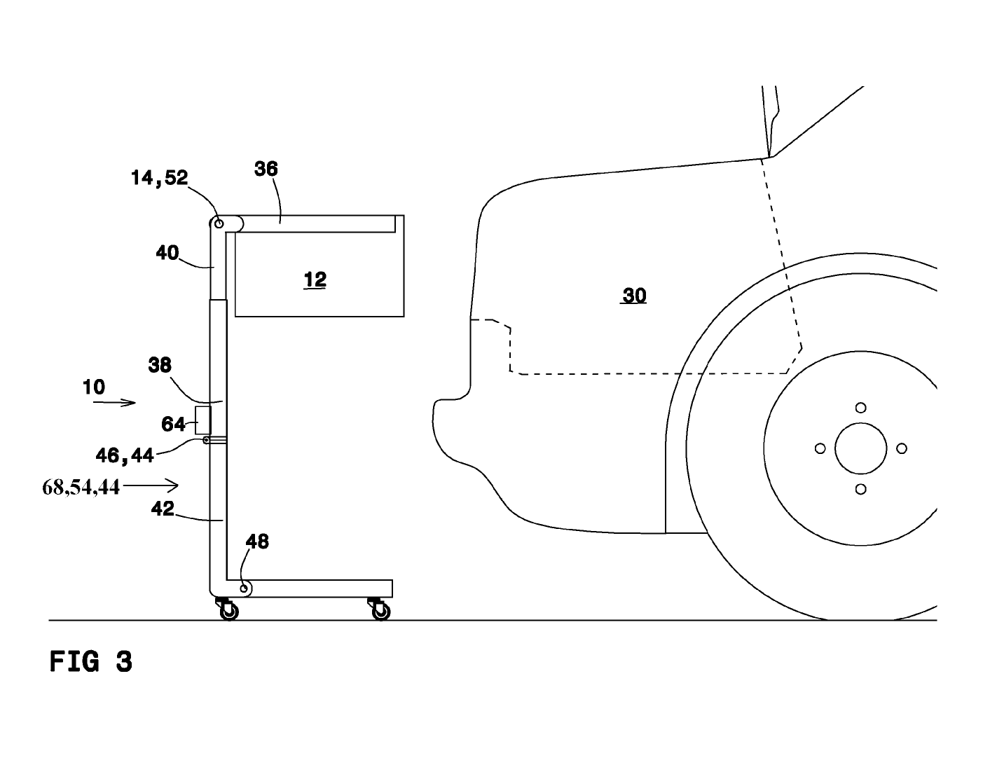

FIG. 3 is a side view of the cart of FIG. 1 brought towards a car's trunk.

Each of pedestals 10 may be folded or reduced by a reducing mechanism 68, for being inserted into trunk 30.

The term “tube” refers herein to a hollow cylinder or to a hollow bar or to other longitudinal hollow component.

According to this embodiment, the reducing mechanism 68 of pedestal 10 combines a telescopic mechanism 54, including telescopic tubes 38 and 40, which may move one into the other, together with a folding mechanism 44, including a vertical arm 42, which is rotatable about a hinge 44.

Telescopic mechanism 54 may reduce or extend the length of the telescopic portion of pedestal 10. Telescopic mechanism 54 may utilize an electric motor 64 or a pneumatic mechanism (“piston”) or other.

The terms “forward”, “front”, “backward”, “rear”, “in front”, “behind”, etc. relate to a trunk located at the rear of the car.

For a rear car's trunk, cart 2 is brought towards car trunk 30 such that bottom horizontal bars 34 and top horizontal bars 36 face trunk 30, whereas pedestal 10 is behind.

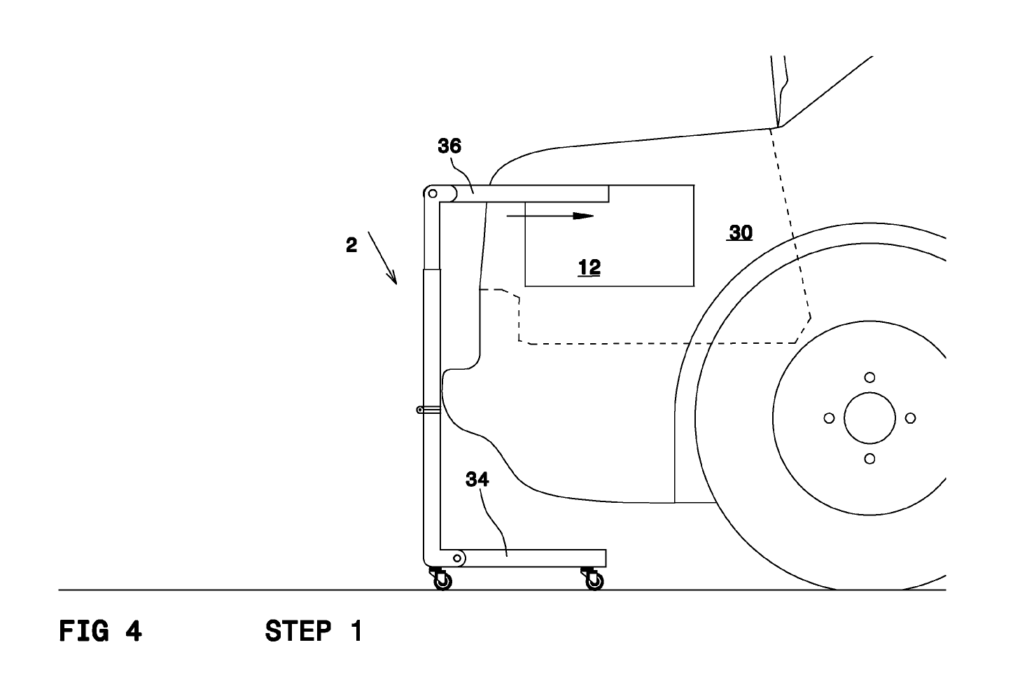

FIG. 4 is a side view of the first step of folding the cart of FIG. 1 into the car trunk.

Since top horizontal bars 36 and bottom horizontal bars 34 both extend to the same side of pedestals 10, upon bringing cart 2 even closer to the front, bottom horizontal bars 34 are located beneath car's trunk 30 and top horizontal bars 36 are located above trunk 30.

At the first step the user manually slides luggage box 12 horizontally along slideable connection 62 forward, in relation to top horizontal bars 34.

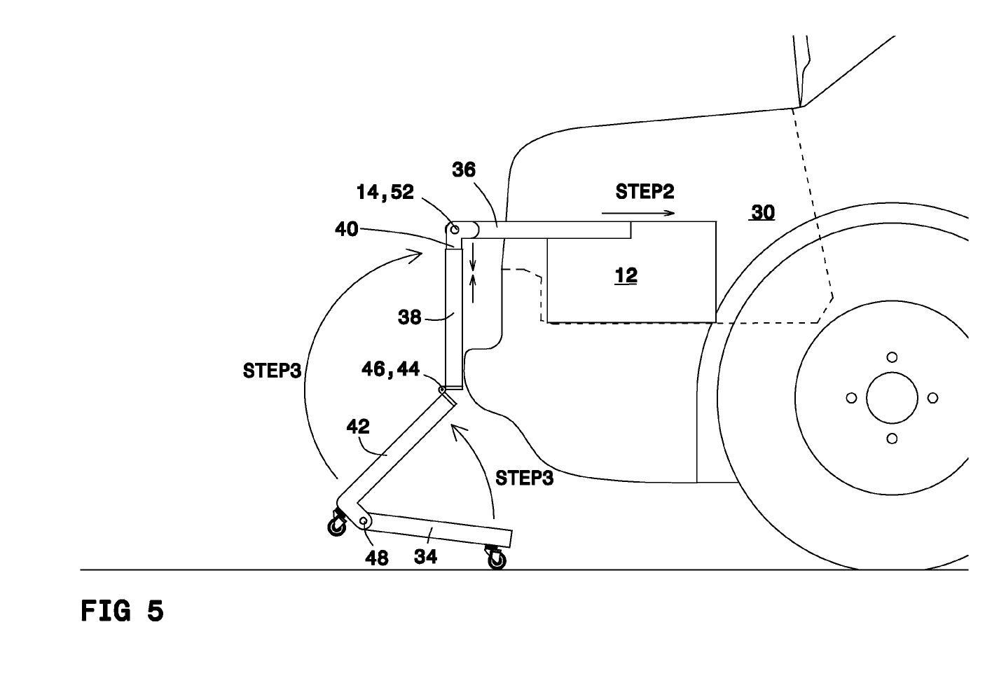

FIG. 5 is a side view of the second and third steps of folding the cart of FIG. 1 into the car trunk.

At the second step, tube 40 is inserted by the motor into tube 38, lowering top horizontal bars 34 together with luggage box 12, until resting on the floor of trunk 30. At this state pedestal 10 no longer is required for supporting cart 2.

Tube 40 is inserted even deeper into tube 38, raising bottom horizontal bars 34 above the floor.

At the third step, the user may manually, without any motor, rotate vertical arms 42 upwards about hinges 44 towards tube 38 by 180 degrees.

And the user may release latches 22, and then manually rotate each of bottom horizontal bars 34 90 degrees upward about a hinge 48 between horizontal bars 34 and vertical arm 42, being folded to be attached to vertical arm 42 thereof.

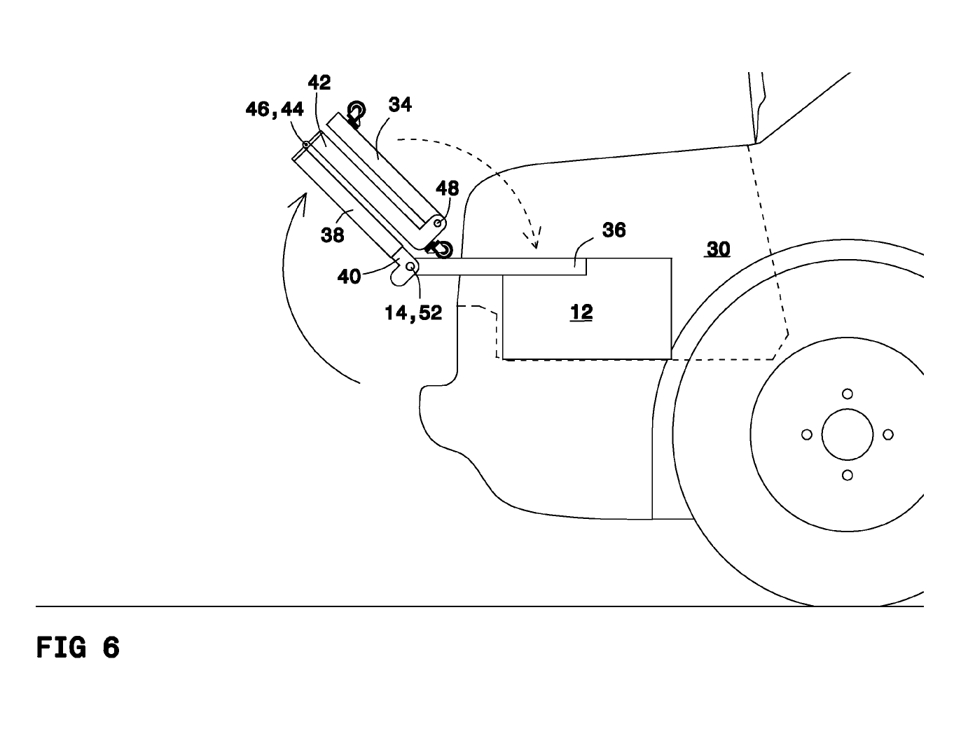

FIG. 6 is a side view of the result of the third step of FIG. 5. At the end of the third step, bars 34 and vertical arms 42 are attached to tube 38.

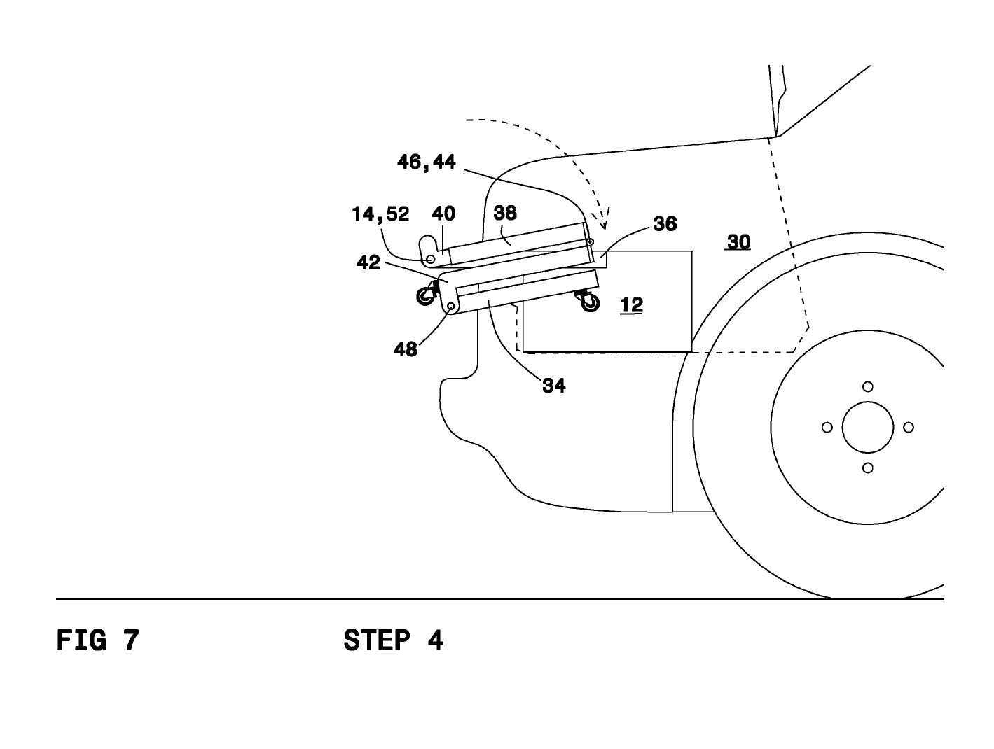

FIG. 7 is a side view of the fourth step of folding the cart of FIG. 1 into the car trunk.

At the fourth step, the user may manually rotate bottom bar 34 and vertical arm 42 attached to tube 38 together 270 degrees about a pivot 52, being folded to be disposed at the side of top horizontal bar 34 and at the side of luggage box 12.

However, joining bar 46 which connects the right pedestal and the left pedestal 10, i.e., crosses from side to side, is disposed at the folded state above top horizontal bar 36.

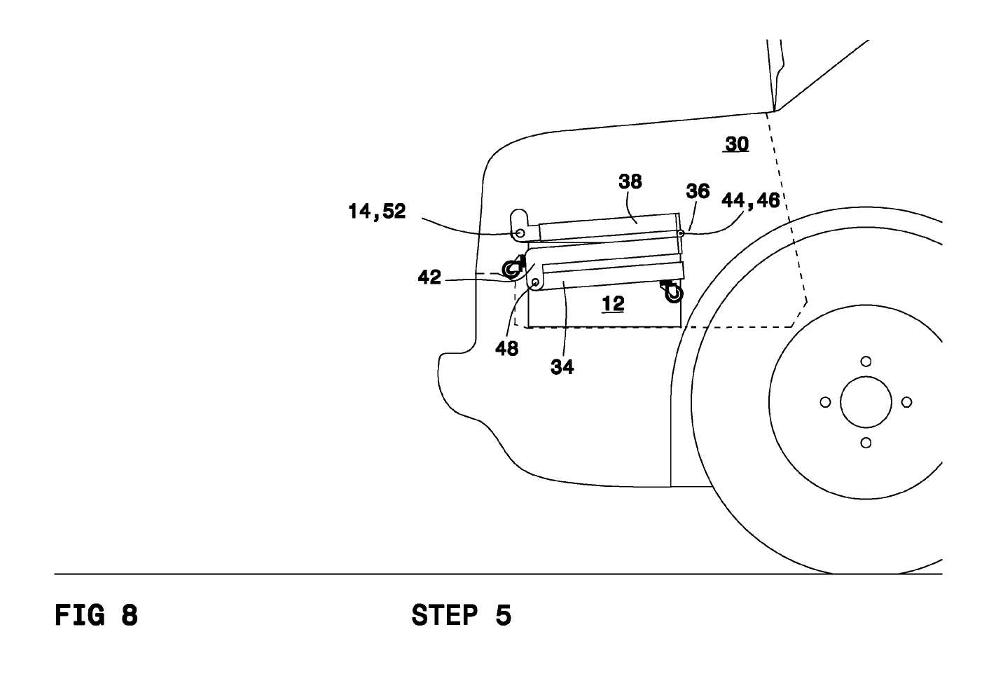

FIG. 8 is a side view of the fifth step of folding the cart of FIG. 1 into the car trunk.

At the fifth step, the user may slide bars 34, 42 attached to tube 38 forward in relation to luggage box 12 along slideable connection 62. Joining bar 46 may be disposed in front of luggage box 12, reducing the height of cart 2 at that folded state, saving space above luggage box 12.

Then the trunk may be closed by the cover of trunk 30.

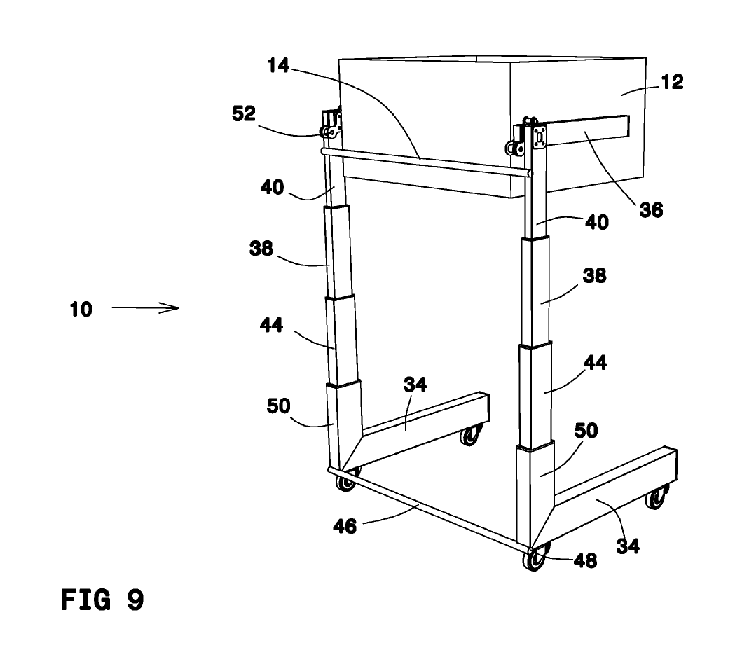

FIG. 9 is a perspective view of a cart according to another embodiment of the present invention.

Like FIG. 1, cart 2, according to this embodiment, also includes top horizontal bars 36 supported by two telescopic vertical pedestals 10, each on a bottom horizontal bar 34, one at the left and one at the right. Pedestals 10 and bottom horizontal bar 34 thereof together include four wheels 18.

According to this embodiment, each of the entire pedestals 10 includes telescopic tubes which may move one into the other by telescopic mechanism 54. According to the example of FIG. 9, each of pedestals includes from top to bottom tubes 40, 38, 44 and external tube 50.

Like FIG. 1, cart 2 according to this embodiment also features horizontal handle 14 or luggage box 12 at the top, and horizontal rod 46 below connect the side bars completing the frame of the cart. Horizontal rod 46 of this embodiment is disposed on the lowest tube 50.

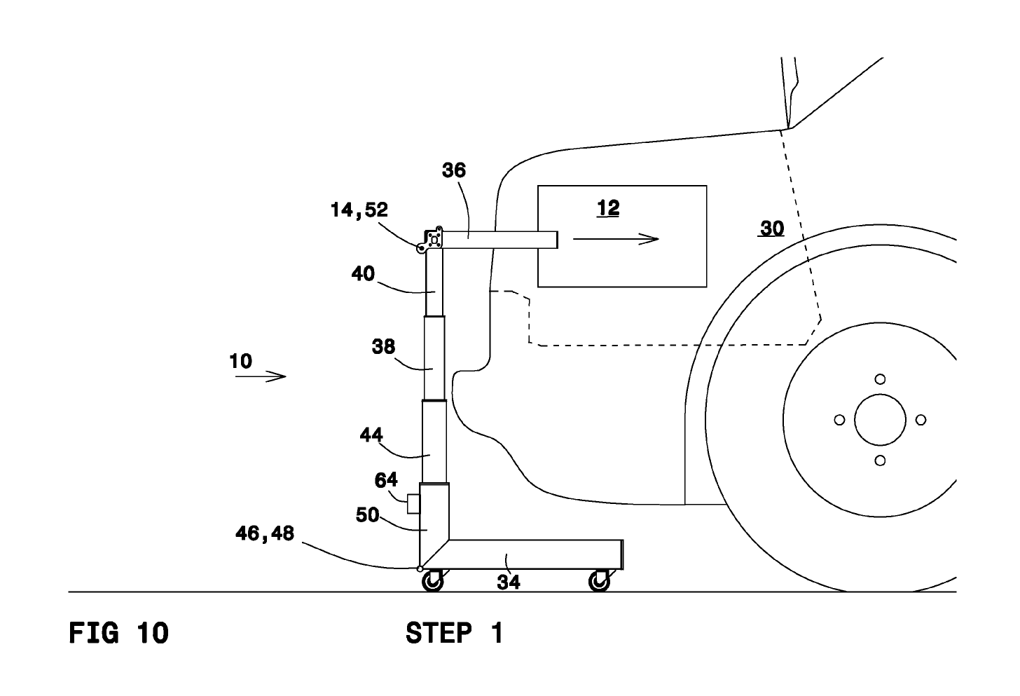

FIG. 10 depicts the first and second steps of inserting the cart of FIG. 9 into the car trunk.

Like FIG. 1, upon bringing cart 2 of this embodiment to the front, bottom horizontal bars 34 are located beneath car trunk 30 and top horizontal bars 36 are located above trunk 30.

Like FIG. 1, at the first step the user manually slides luggage box 12 horizontally along slideable connection 62 forward, in relation to top horizontal bars 34.

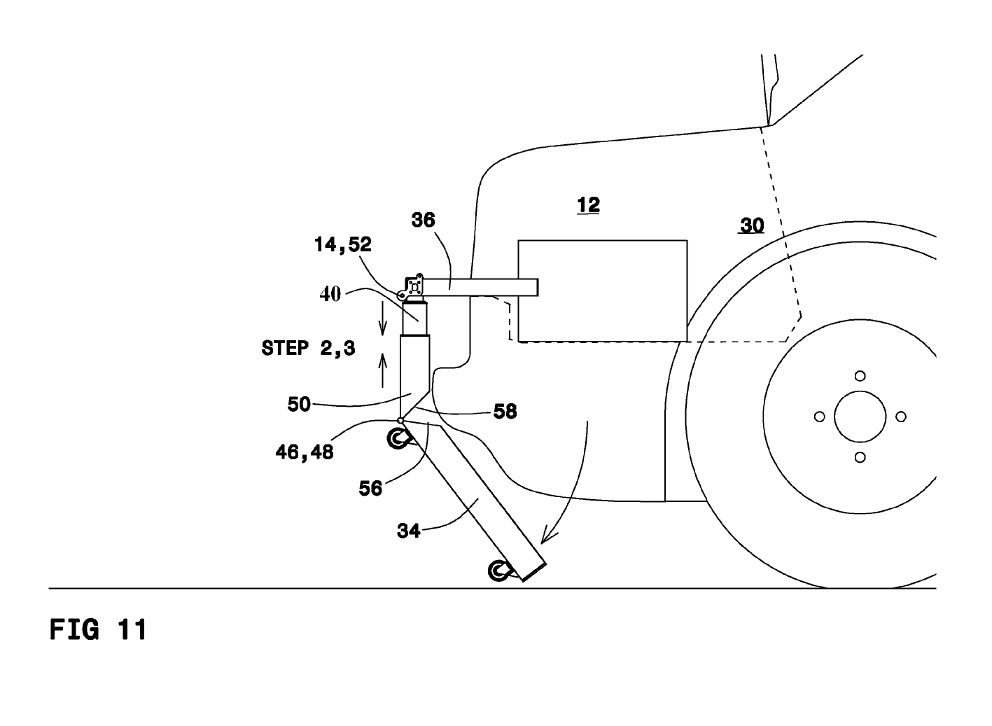

FIG. 11 depicts the second and third step of inserting the cart of FIG. 9 into the car trunk.

At the second step, the user activates telescopic mechanism 54 to lower luggage box 12 by diminishing telescopic pedestal 10 into tube 50, such that luggage box 12 rests on the floor of trunk 30.

At the third step, telescopic pedestal 10 is diminished even deeper. Cart 2 is not based on the ground any more.

Hinge 48 between horizontal bars 34 and external tube 50 rotates horizontal bars 34 upon being lifted from the floor.

The rotation for folding is directed in the opposite direction of FIG. 5. Thus, FIG. 11 depicts that the deployed state of this embodiment is advantaged of being based on gravity only. The deployed state attaches diagonal sides 56 of bottom horizontal bars 34 to diagonal bottom sides 58 of external tube 50 of pedestal 10, thus disposing bottom horizontal bars 34 perpendicular to pedestals 32. Thus, safety latches 22, which are a must for FIG. 1, may provide this embodiment an extra safety level.

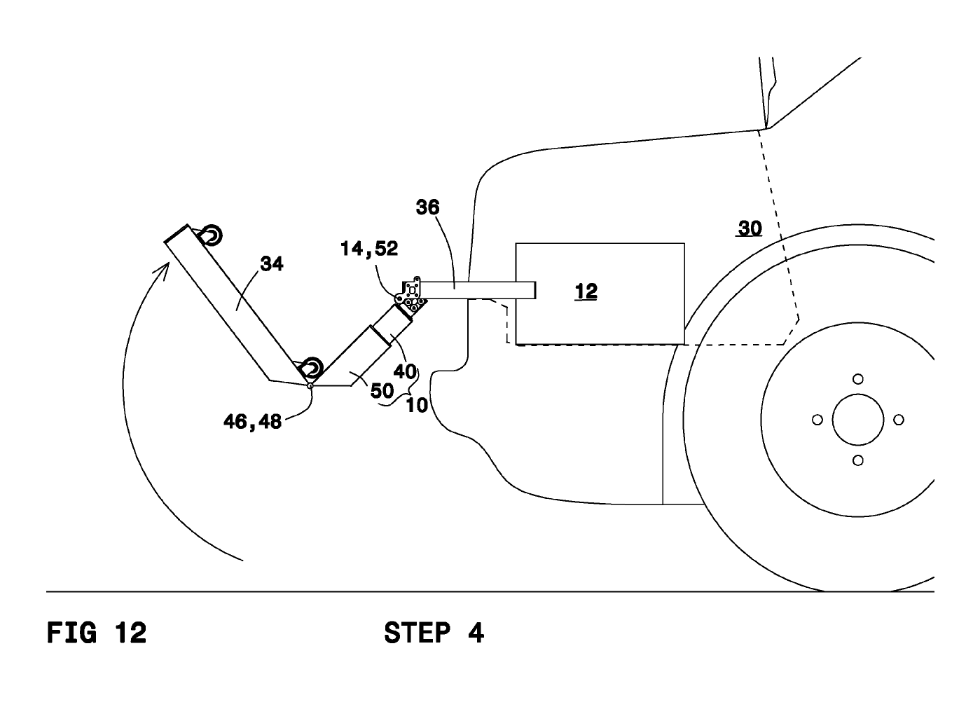

FIG. 12 depicts the fourth step of inserting the cart of FIG. 9 into the car trunk.

At the fourth step, the user may manually rotate each of the bottom horizontal bars 34, which were perpendicular to pedestal 32 thereof, 270 degrees about hinge 48, until attaching external tube 50 of pedestals 10 from the back.

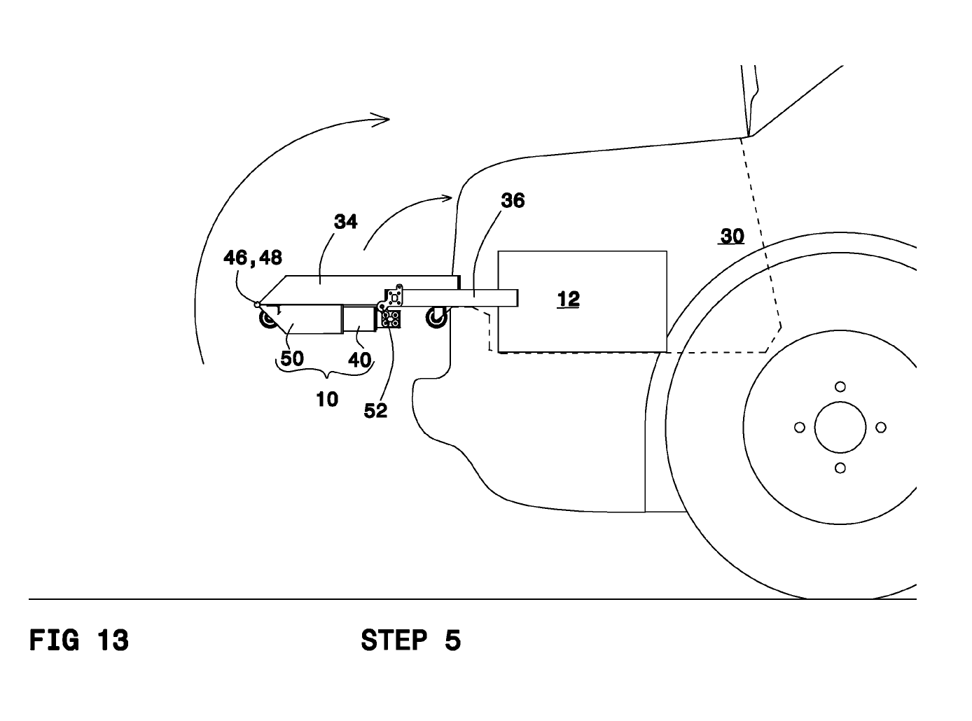

FIG. 13 depicts the fifth step of inserting the cart of FIG. 9 into the car trunk.

For illustration purposes, FIG. 13 depicts only the bottom horizontal bar 34 and pedestal 10 behind, indicating that bottom horizontal bar 34 and pedestal 10 are disposed at the side of top horizontal bars 36.

According to this embodiment, pivot 52 allows rotation between tube 40, which is the internal and highest tube of pedestal 10, and top horizontal bar 36.

At the fifth step, the user may manually rotate bottom horizontal bars 34 together with the pedestals, 270 degrees about pivot 52 from the vertical position to a horizontal position mostly in trunk 30 above luggage box 12.

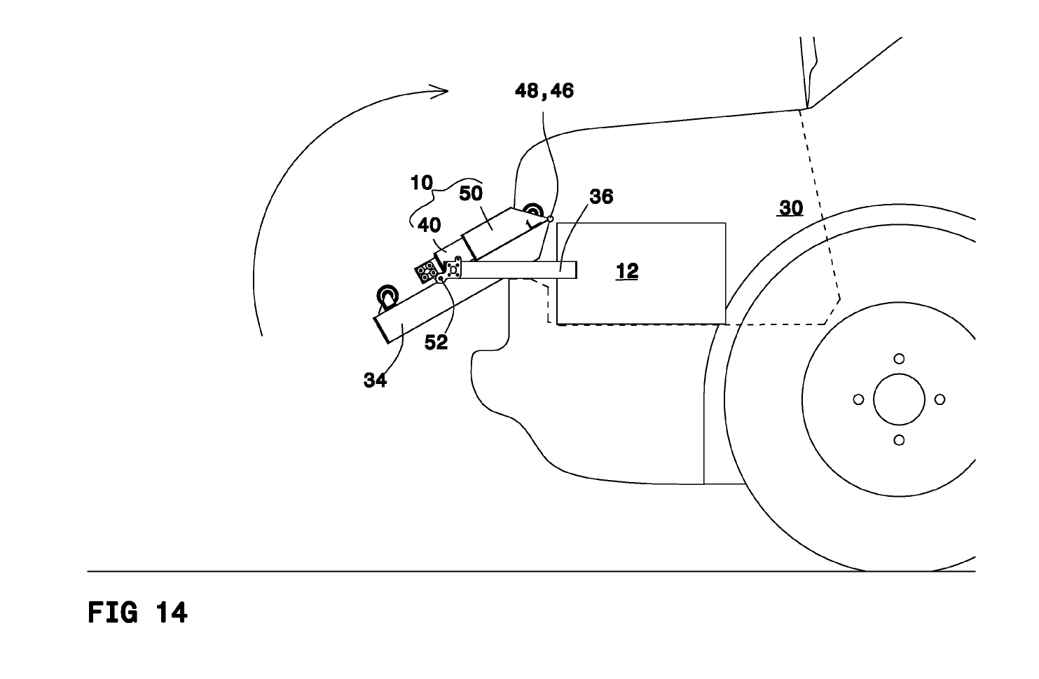

FIG. 14 depicts the resulting state of the fifth step of FIG. 13.

After the fifth step joining bar 46, which connects the two pedestals 10 is disposed at the front of pedestals 10, i.e. right to pedestals 10 in FIG. 14.

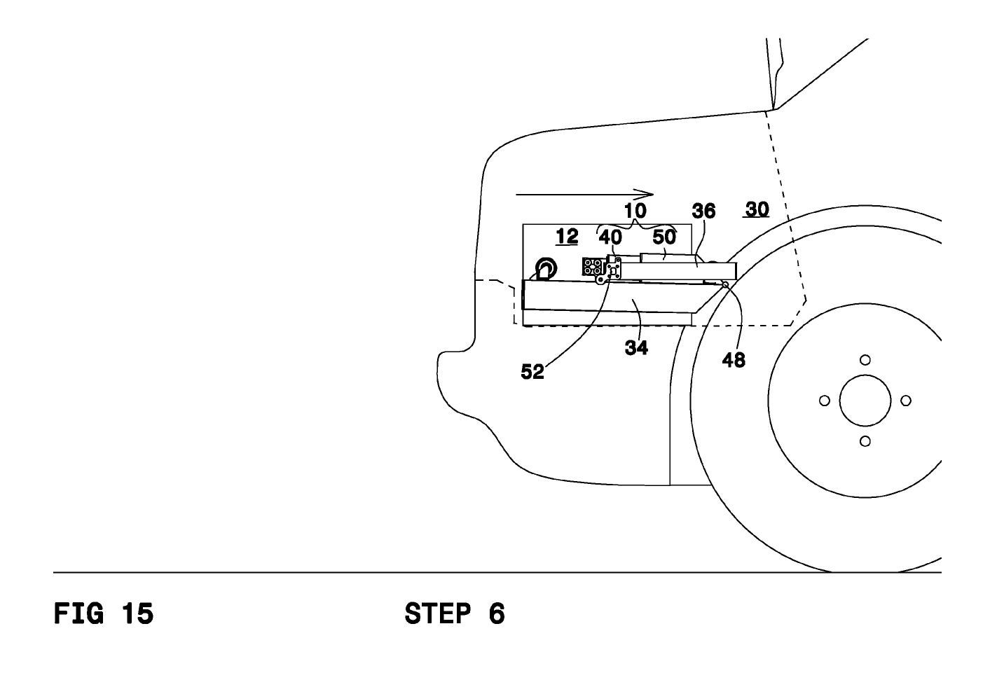

FIG. 15 depicts the sixth step of inserting the cart of FIG. 9 into the car trunk.

Like the fifth step of the cart of FIG. 1, the user may, at the sixth step of this embodiment, slide the frame including bars 34, pedestals 10 and bars 36 forward in relation to luggage box 12 along slideable connection 62.

Joining bar 46 may be disposed in front of luggage box 12, allowing being disposed below the top of luggage box 12, for reducing the overall height.

Then the trunk may be closed by the cover of trunk 30.

According to another embodiment, at the fifth step the user may manually rotate bottom horizontal bars 34 together with the pedestals only 90 degrees instead of 270 degrees about pivot 52, resulting in the state that joining bar 46 is behind pedestals 10, i.e., left close to shown in FIG. 13.

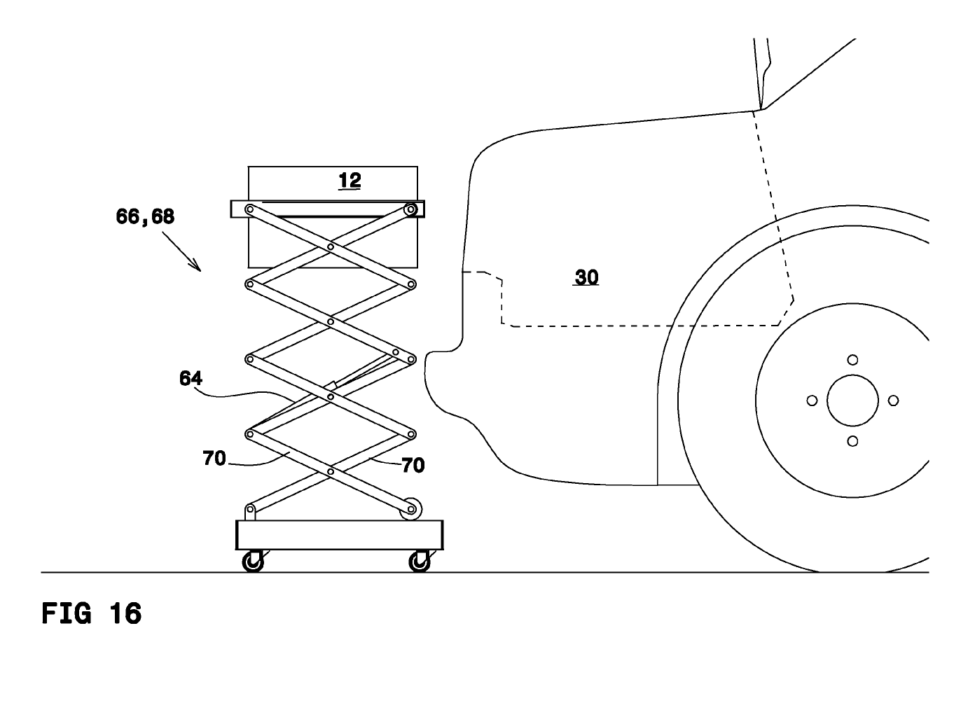

FIG. 16 depicts another reducing mechanism, for reducing the pedestal.

Reducing mechanism 68 may be a crossbreed folding mechanism 66, including a plurality of crossed hinged bars 70. An electric motor 64 or a pneumatic mechanism (“piston”) or other means may activate the reducing mechanism 68 by non-manual force.

In the figures and/or description herein, the following reference numerals have been mentioned:
numeral 10 denotes a pedestal;
numeral 12 denotes a luggage box;
numeral 14 denotes a handle;
numeral 16 denotes a user interface;
numeral 18 denotes a wheel;
numerals 20 and 22 denote safety latches;
numeral 24 denotes a button for raising the luggage box;
numeral 26 denotes a button for lowering the luggage box;
numeral 28 denotes a button for locking or unlocking the safety latches;
numeral 30 denotes a trunk, such as of a car;
numeral 32 denotes a telescopic pedestal;
numeral 34 denotes a bottom horizontal bar, i.e., a horizontal bar close to the floor;
numeral 36 denotes a top horizontal bar supporting the luggage box;
numerals 38 and 40 denote telescopic tubes of the pedestal;
numeral 42 denotes a vertical bar of the pedestal;
numeral 44 denotes a hinge;
numeral 46 denotes a horizontal bar, connecting the two pedestals to a frame;
numeral 48 denotes a hinge between the bottom horizontal bar and the pedestal;
numeral 50 denotes the bottom tube of the pedestal;
numeral 52 denotes a pivot between the top horizontal bar and the pedestal;
numeral 54 denotes a telescopic mechanism, for reducing or extending the length of the pedestals;
numeral 56 denotes a diagonal side of the bottom horizontal bar;
numeral 58 denotes a diagonal side of the pedestal;
numeral 60 denotes a frame or a support for a basket; and
numeral 62 denotes a slideable connection, allowing sliding between two components;
numeral 64 denotes an electric motor or other means, for activating the reducing mechanism by non-manual force;
numeral 66 denotes a crossbreed mechanism, for folding the pedestal; and
numeral 68 denotes a reducing mechanism, which may include the telescopic mechanism, the folding mechanism, the crossbreed folding mechanism, or other.

The foregoing description and illustrations of the embodiments of the invention has been presented for the purposes of illustration. It is not intended to be exhaustive or to limit the invention to the above description in any form.

Any term of the claims that has been defined above, has to be interpreted according to this definition.

What is claimed is:

1. A foldable and deployable cart, said cart comprising:
at least one pedestal substantially perpendicular to the floor at the deployed state;
at least one top horizontal bar, substantially perpendicular to said at least one pedestal at the deployed state;
pivotal connection between said at least one pedestal and said at least one top horizontal bar, for rotating said at least one pedestal thereabout to be substantially parallel to said at least one top horizontal bar,
thereby allowing resting a luggage box, supported by said at least one top horizontal bar, on a trunk and folding said at least one pedestal into said trunk.

2. A cart according to claim 1, wherein:
said at least one pedestal may comprise two pedestals, one at the left and one at the right of said luggage box;
said at least one top horizontal bar may comprise two top horizontal bars, one at the left and one at the right of said luggage box;
thereby said folding of said at least one pedestal may comprise folding thereof to the sides of said luggage box, saving space above said luggage box.

3. A cart according to claim 2, further comprising:
at least one joining bar between said two pedestals; and
at least one joining bar between said two top horizontal bars,
thereby forming a frame.

4. A cart according to claim 3, wherein said at least one joining bar is disposed in front of or behind said luggage box at the folded state of said cart,
thereby saving space above said luggage box.

5. A cart according to claim 1, wherein said rotation of said at least one pedestal to be substantially parallel to said at least one top horizontal bar may comprise: rotation of substantially 270 degrees from said state of perpendicularity to the floor.

6. A cart according to claim 1, wherein said rotation of said pedestal to be substantially parallel to said top horizontal bar may comprise: rotation of substantially 90 degrees from said state of perpendicularity to the floor.

7. A cart according to claim 1, further comprising:
a reducing mechanism, for reducing the length of said at least one pedestal.

8. A cart according to claim 7, wherein said reducing mechanism may comprise a folding mechanism for folding arms of said at least one pedestal one towards the other.

9. A cart according to claim 7, wherein said reducing mechanism may comprise a telescopic mechanism for providing telescopic reduction of said at least one pedestal.

10. A cart according to claim 7, wherein said reducing mechanism may comprise a crossbreed folding mechanism providing crossbreed folding reduction of said at least one pedestal.

11. A cart according to claim 1, further comprising at least one bottom horizontal bar extending said at least one pedestal substantially perpendicular thereto at said deployed state, said bottom horizontal bar for supporting said pedestal.

12. A cart according to claim 1, further comprising:
a luggage box resting on said at least one horizontal bar; and
slideable connection between said luggage box or support of said luggage box and said at least one horizontal bar.

13. A cart according to claim 7, wherein said at least one bottom horizontal bar is pivotally connected to said at least one pedestal, for folding said at least one bottom horizontal bar to be attached to said at least one pedestal at said folded state.

14. A method for using a cart, said method comprising the steps of:
disposing a luggage box of said cart above a trunk;
resting said luggage box on said trunk; and
rotating at least one pedestal of said cart, for folding said at least one pedestal into said trunk.

15. A method according to claim 14, wherein said step of disposing said luggage box above said trunk may comprise disposing bottom horizontal bars of said cart beneath said trunk.

16. A method according to claim 14, further comprising the step of:
sliding said luggage box horizontally in relation to said at least one pedestal.
